(19) United States
(12) Patent Application Publication
(10) Pub. No.: US 2021/0129056 A1
(43) Pub. Date: May 6, 2021

(54) FILTER CARTRIDGE LOCKING ASSEMBLY

(71) Applicant: Baldwin Filters, Inc., Kearney, NE (US)

(72) Inventors: Steven J. Merritt, Kearney, NE (US); Jonathan D. Moore, Ellington, CT (US); Robert H. Volk, Broadbrook, CT (US); Scott A. Blaschko, Kearney, NE (US)

(21) Appl. No.: 17/053,497

(22) PCT Filed: May 7, 2019
(86) PCT No.: PCT/US2019/031136

§ 371 Date: Nov. 6, 2020

Related U.S. Application Data
(60) Provisional application No. 62/668,308, filed on May 8, 2018.

(51) Int. Cl. B01D 35/30

(52) U.S. Cl. CPC B01D 35/306; B01D 2201/4076; B01D 2201/4092; B01D 2201/304

(57) ABSTRACT

The filter cartridge locking assembly is configured to secure a collar within a housing of a filter cartridge. The collar includes first and second ends and fits into a circumferential retainer included on the housing. At least one notch is formed between the first and second ends of the collar for mating with at least one complimentary bead included on the retainer. An annular gap is defined on the collar for receiving a portion of the retainer. The retainer also receives a portion of the collar. The retainer is comprised of a first leg that extends radially outwardly and a second leg that extends substantially perpendicular to the first leg. The first and second legs interact with the collar in a surface-to-surface relationship while the at least one bead engages the at least one notch to form an axially and rotationally locked coupling between the housing and the collar.

### BACKGROUND

The present disclosure relates generally to devices for filtering fluids. More particularly, the present disclosure relates to fuel filter cartridges for removing particulates and separating water from fuel being delivered to an internal combustion engine.

Significant quantities of contaminants such as abrasive particles and water are found in diesel fuel. Abrasive particles may damage sensitive engine components such as the fuel injection pump. Likewise, in addition to corroding metal components, water may obstruct the fuel lines when environmental temperatures fall below freezing. It is necessary to remove particulates and water from fuel before the fuel is supplied to an engine in order to ensure that the engine operates properly and has a long service life.

Fuel filter cartridges are a well-known solution for removing particulates and water from fuel before the fuel is pumped into sensitive engine systems. These known filter cartridges typically have a housing which defines an axial opening at one end to provide fuel communication between the fuel delivery system and a filter element disposed within the filter cartridge housing. Customarily, the filter cartridge housing comprises two separate shell portions, one of which defines the axial opening. Filter elements typically comprise a ring of fuel filter media and a pair of end caps. The filter media typically comprises non-woven material, while one end cap is typically an imperforate cover to which one end of the fuel filter media is permanently affixed.

In some filter cartridge configurations, two metal cans are connected by a roll seam to form the filter cartridge housing. Here, the filter cartridge housing may then be attached by a separate collar member of a filter head having an inlet and an outlet port adapted for attachment of fluid lines directing fluid into and away from the filter cartridge. In other configurations, there may be threads on the filter cartridge itself that allow for the filter cartridge to threadably mount to the filter head.

In cases where the filter cartridge itself is threadably mounted to the filter head, it is desirable to prevent the filter element from backing off or becoming detached from the filter head. For this, the construction of the housing of such filter cartridges requires some form of positive locking assembly to maintain the integrity of the housing when the filter cartridge is spun-on to the filter head. Prior art locking assemblies include disadvantages associated with complexity and practicality of manufacturing.

It is desirable to provide an improved filter cartridge locking assembly in a manner that fulfills one or more of the needs described above.

### SUMMARY

According to aspects illustrated herein, the filter cartridge locking assembly (hereafter, “the locking assembly”) is configured to couple and secure parts of a filter cartridge without the use of excess components and/or complex manufacturing. Specifically, the locking assembly rotationally and axially locks a collar member within a housing.

The housing of the locking assembly defines a cavity and includes first and second ends and an annular sidewall extending therebetween. A circumferential retainer is included at the first end of the housing for securing the collar. A filter element is situated within the cavity of the housing and an annular filtration space is defined between the filter element and the housing for filling with dirty fluid. The filter element includes a cylindrical ring of filter media disposed about a longitudinal axis and extends axially between a first endcap and a second endcap. The first endcap defines an outlet having a first gland that receives a first annular seal which seals against an outlet passage defined by the filter head to separate clean and dirty fluid.

The collar includes first and second ends and fits into the circumferential retainer included at the first end of the housing. At least one notch is formed between the first and second ends of the collar for mating with at least one complimentary bead included on the circumferential retainer. Mounting threads are positioned between the first and second ends of the collar for threadably attaching to the filter head. An annular outwardly extending flange is positioned between the mounting threads and the second end for preventing overtightening of the collar to the filter head. A first annular gap having a first axial length is defined between the mounting threads and the flange for receiving a bottom surface of the filter head. A second annular gap having a second axial length is defined between the flange and the second end for receiving the circumferential retainer. The first end of the collar includes a second gland that receives a second annular seal which seals against the interior of the filter head to separate dirty fluid from an area outside of the filter cartridge. The second end of the collar includes a third gland that receives a third annular seal which seals against the housing to prevent leakage from the filter cartridge.

The circumferential retainer is included at the first end of the housing and receives the second end of the collar. The retainer is comprised of a first leg that extends radially outwardly, a second leg that extends substantially perpendicular to the first leg, and the at least one peripheral bead. The retainer extends outwardly to define an outwardly flared annular clearance for fitting around the third gland.

In this arrangement, the second leg interacts surface-to-surface with the second annular gap and the at least one bead engages the at least one notch to form an axially and rotationally locked coupling between the housing and the collar without excess components and/or complex manufacturing.

According to aspects illustrated herein, a method of making the locking assembly comprises providing a filter housing that defines a cavity and includes first and second ends and an annular sidewall extending therebetween. A filter element is inserted into the housing and includes a cylindrical ring of filter media that is disposed about a longitudinal axis. The filter media extends axially between first and second endcaps. The first endcap defines an outlet having a first gland that receives a first annular seal which seals against an outlet passage defined by the filter head to separate clean and dirty fluid.

A collar having first and second ends fits into the first end of the housing. At least one notch is formed between the first and second ends of the collar. Mounting threads are positioned between the first and second ends of the collar and an annular outwardly extending flange is positioned between the mounting threads and the second end. A first annular gap having a first axial length is defined between the mounting threads and the flange and a second annular gap having a second axial length is defined between the flange and the second end. The first end of the collar includes a second gland that receives a second annular seal which seals against the interior of the filter head to separate dirty fluid from an area outside of the filter cartridge. The second end of the collar includes a third gland that receives a third annular seal which seals against the housing to prevent leakage from the filter cartridge.

A circumferential retainer is formed at the first end of the housing and receives the second end of the collar. The retainer is comprised of a first leg that extends radially outwardly, a second leg that extends substantially perpendicular to the first leg, and at least one peripheral bead.

In this arrangement, positioning the second leg into the second annular gap and engaging the at least one bead with the at least one notch forms an axially and rotationally locked coupling between the housing and the collar.

### BRIEF DESCRIPTION OF THE DRAWINGS

Aspects of an embodiment will be described in reference to the drawings, where like numerals reflect like elements:

FIG. 1 is a front view of the filter cartridge locking assembly (hereafter, “the cartridge”) according to aspects of the disclosure;

FIG. 2 is a front cross-sectional view of the filter cartridge of FIG. 1;

FIG. 3 is a partial front cross-sectional view of a circumferential retainer and a collar of the cartridge according to aspects of the disclosure;

FIG. 4 is a partial front cross-sectional view of the circumferential retainer and the collar of the cartridge according to aspects of the disclosure;

FIG. 5 is a partial front cross-sectional view of an alternative embodiment of the circumferential retainer and the collar of the cartridge according to aspects of the disclosure;

FIG. 6 is a partial front cross-sectional view of an alternative embodiment of the circumferential retainer and the collar of the cartridge according to aspects of the disclosure;

FIG. 7 is a partial front cross-sectional view of an alternative embodiment of the circumferential retainer and the collar of the cartridge according to aspects of the disclosure, and

FIG. 8 is a partial front cross-sectional view of an alternative embodiment of the circumferential retainer and the collar of the cartridge according to aspects of the disclosure.

### DETAILED DESCRIPTION

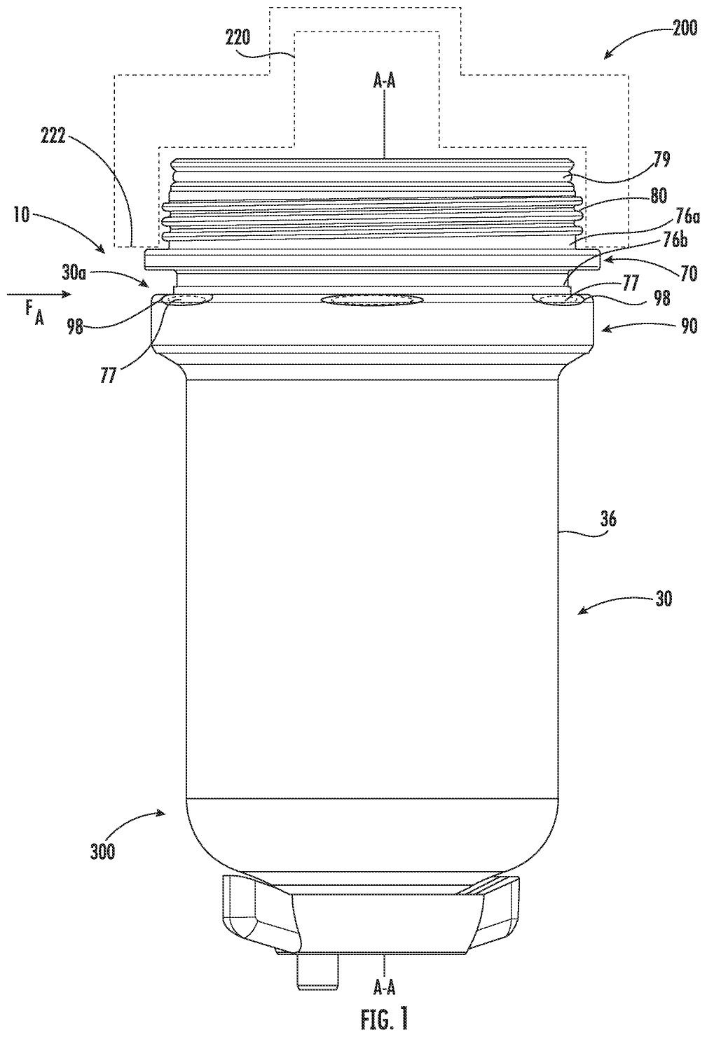

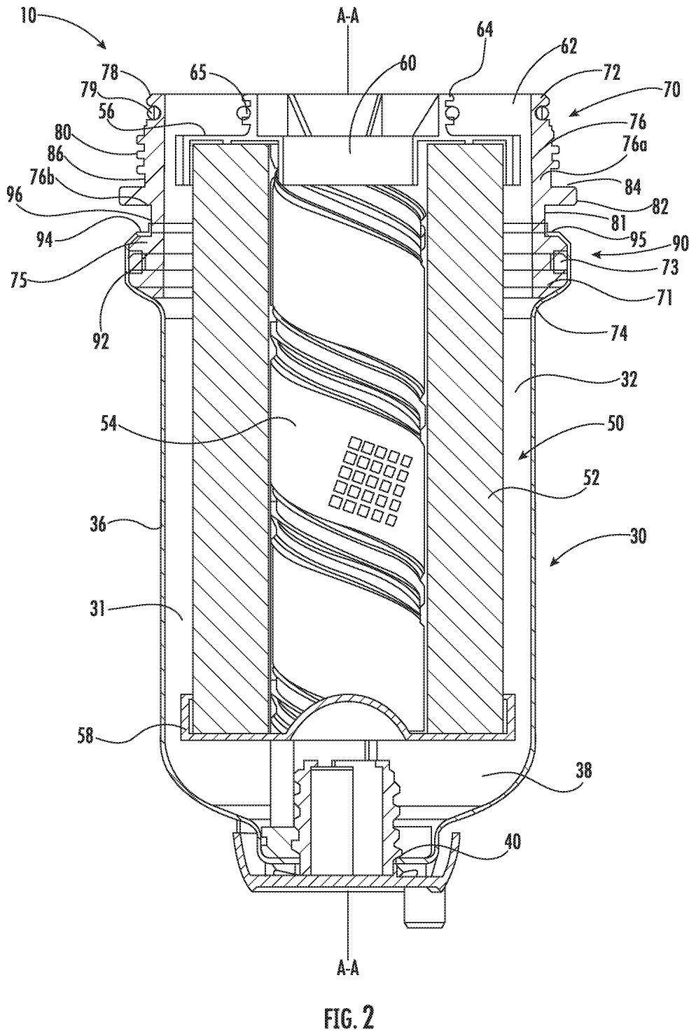

An embodiment of a filter cartridge locking assembly (hereafter, “the cartridge”) according to aspects of the disclosure will now be described with reference to FIGS. 1 and 2. The filter cartridge will generally be referred to by the reference numeral 10. Various materials, methods of construction, methods of manufacture, and methods of fastening will be discussed in the context of the disclosed embodiments. Those skilled in the art will recognize known substitutes for the materials, manufacturing methods, and fastening methods, all of which are contemplated as compatible with the disclosed embodiments and are intended to be encompassed by the appended claims.

As shown in FIG. 1, the filter cartridge 10 is contemplated for use in a fluid filter assembly within a fluid filtration system. The filter cartridge 10 is configured to be spun-on and threadably mounted to a filter head 200 within the filter assembly. The filter cartridge includes a housing 30, a filter element 50 situated within the housing 30, a collar 70 arranged concentrically about the filter element 50, and a circumferential retainer 90 formed on the housing 30 for receiving and securing the collar 70.

Referring to FIG. 2, the filter element 50 includes a cylindrical ring of filter media 52 disposed about a longitudinal axis A-A. The filter media 52 circumscribes a coaxial center tube 54 extending between an upper (first) endcap 56 and a closed lower (second) endcap 58 and is attached to the upper and lower endcaps 56, 58 in a fluid-tight relationship. In the disclosed embodiment, the term “filter media” applies to fibrous and/or permeable structures and materials intended to remove particulates from a fluid flow as well as structures intended to separate water from a fluid flow, such as a hydrophobic or hydrophilic screen or treatment. Water can be rejected at the face of the filter media 52, or can be coalesced during passage through the filter media 52 and then separated at a hydrophobic or hydrophilic screen. In both cases, water can be said to be separated from the flow of fluid as it passes through the filter media 52. When situated in the housing 50, an annular filtration space 32 is defined between the filter element 50 and the housing 30. The first endcap 56 defines an annular clean fluid outlet 60 arranged concentrically with the center tube 54 and an annular dirty fluid inlet 62 offset radially outwardly from the outlet 60. The outlet 60 defines a inner (first) gland 64 for receiving an inner (first) annular seal 65 to seal against an interior surface of an outlet passage 220 (see FIG. 1) defined by the filter head 200. The inner seal 65 separates clean fluid from dirty fluid.

As illustrated by FIGS. 1 and 2, the filter element 50 is inserted into and fits within a cavity 31 defined by the housing 30. The housing 30 includes an open upper (first) end 30a, a closed dome-shaped lower (second) end 30b, and an annular sidewall 36 extending between the upper and lower ends.

In the above arrangement, dirty fluid flows through the inlet 62 and fills the filtration space 32. The dirty fluid flows radially inward through the filter media 52 separating particulates and water from the fluid. Clean fluid flows into the center tube 54 and upwardly through the outlet 60 to the outlet passage 220 (see FIG. 1) defined by the filter head 200.

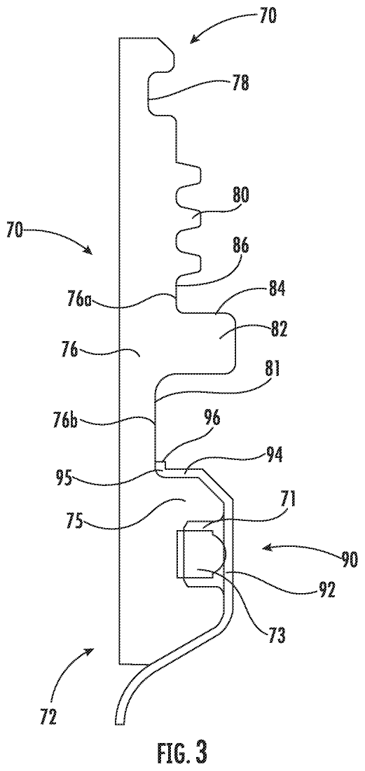

As shown in FIGS. 2 and 3, the collar 70 is arranged concentrically about the upper endcap 56 of the filter element 50 and defines a flow path for dirty fluid to enter and fill the annular filtration space 32 between the filter element 50 and the housing 30. The collar 70 includes an upper (first) end 72, a lower (second) end 74 and an annular sidewall 76 extending therebetween. The upper end 72 comprises an intermediate (second) gland 78 for receiving an intermediate (second) annular seal 79 and mounting threads 80 positioned below the intermediate gland 78 arranged to threadably mount to the filter head 200. The intermediate seal 79 seals against an interior surface of the filter head 200 to separate dirty fluid in an area above the upper endcap 56 from an area outside of the fluid filter assembly. Each thread 80 is a projection configured to ride along a thread ramp such as a helical channel defined by the filter head 200. For example, the threads 80 may include first and second helical thread ribs. Alternatively, the threads 80 can be another similar helical thread rib structure or can be another projection that is structured and configured to engage and ride along the thread ramp of the filter head 200.

Referring to FIGS. 2 and 3, an annular outwardly extending flange 82 is positioned between the upper and lower ends 72, 74 of the collar 70 and includes an abutment surface 84 which faces a bottom surface 222 of the filter head 200 (see FIG. 1). An upper (first) annular gap 86 is defined between the mounting threads 80, an upper portion 76a of the annular sidewall 76, and the abutment surface 84 of the flange 82. As the filter cartridge 10 is threadably mounted to the filter head 200, the bottom surface 222 of the filter head 200 moves downwardly through the upper gap 86 until the bottom surface 222 of the filter head 200 is adjacent the flange 82. The abutment surface 84 acts as a stop on the filter head 200 to prevent overtightening of the filter cartridge 10 to the filter head 200.

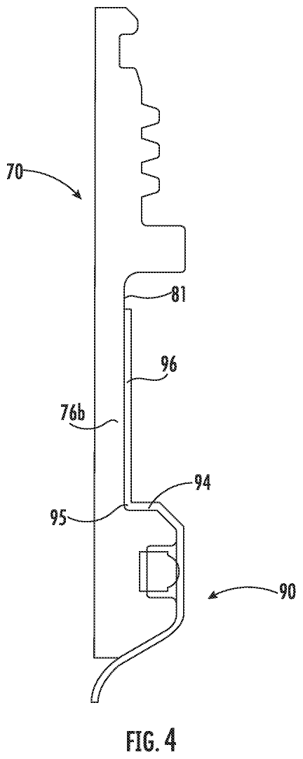

As shown in FIGS. 2 and 3, the lower end 74 of the collar 70 comprises an outer (third) gland 71 for receiving an outer (third) annular seal 73 which seals against an interior surface of the housing 30 to prevent leakage of dirty fluid. The outer gland 71 includes an annular upper shoulder 75 for engaging the retainer 90 formed on the housing 30. The shoulder 75 extends outwardly to a plurality of peripheral notches 77 (shown in dotted lines in FIG. 1) arranged in an annular, radially-spaced array. The notches 77 cooperate with complimentary beads 98 included on the retainer 90 to provide a torque locking mechanism between the collar 70 and the housing 30. The notches 77 may include a generally planar bottom and an arch-shaped sidewall but other shapes and configurations for the notches 77 may also be used. The notches 77 may be cast or stamped into the outer gland 71 or can be machined or cut out. A lower (second) annular gap 81 is defined between the flange 82, a lower portion 76b of the annular sidewall 76, and the shoulder 75 for receiving the retainer 90. As shown in FIGS. 1-4 of the disclosed embodiment, the lower gap 81 extends axially and has a length of 0.25 inches but may have a length in the range of at least 0.02 inches to 1 inch. In this arrangement, the collar 70 is received in the housing 30 and the retainer 90 engages the lower gland 71 and lower portion 76b of the annular sidewall 76 to secure the collar 70 within the housing 30.

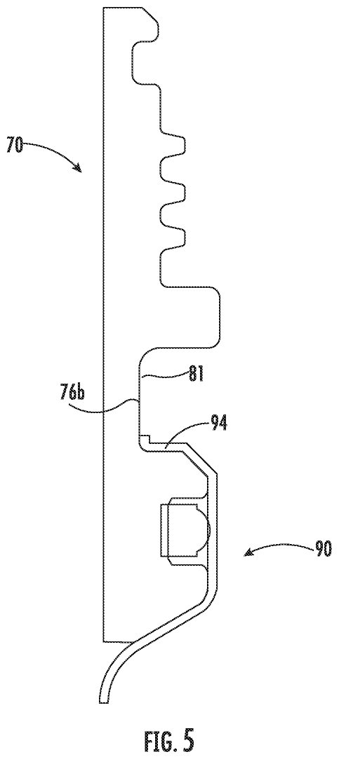

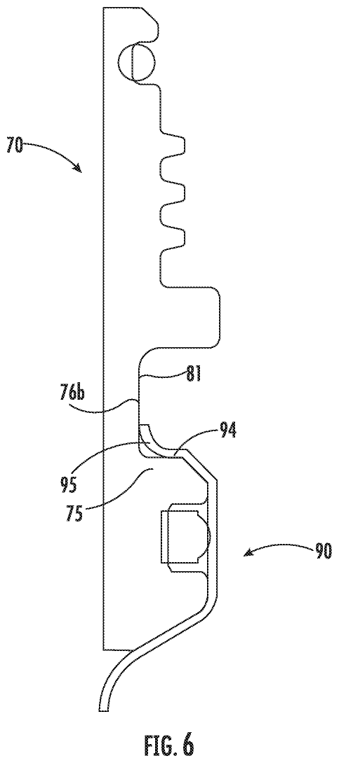

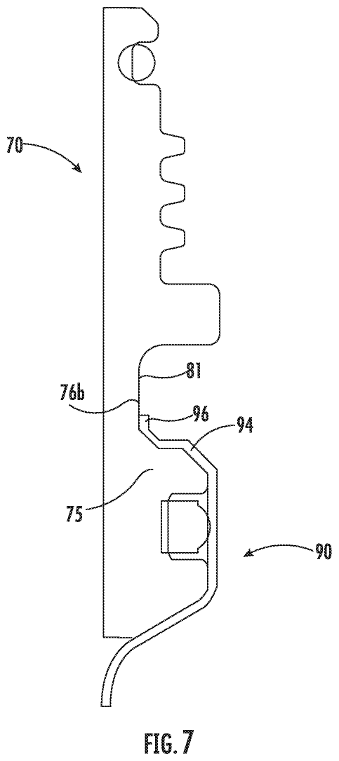

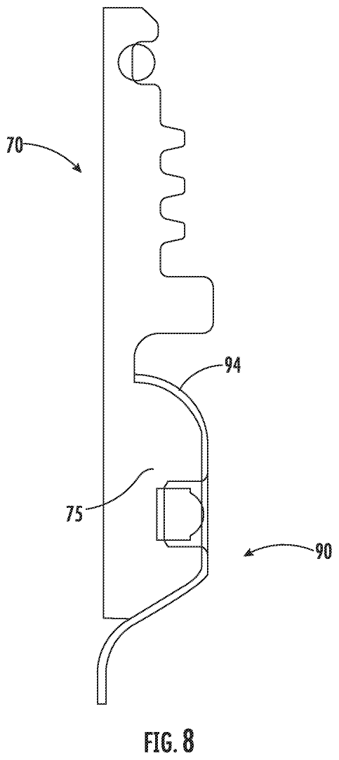

Referring to FIGS. 2 and 3, the circumferential retainer 90 is included at the upper end of the housing 90. The retainer 90 is comprised of an outwardly flared annular clearance 92 defined by the upper end of the housing 30, an outwardly extending first leg 94, a coaxial second leg 96, and a bend 95 extending between the first and second legs 94, 96. In the disclosed embodiment, the first leg 94 has a length of 0.10 inches, or 0.14 inches when adjacent a bead 98, but may have a length in the range of at least 0.02 inches to 1 inch. As illustrated by FIGS. 1-4, the second leg 96 has a length of 0.08 inches but may have a length in the range of at least 0.02 inches to 1 inch. As shown in FIGS. 1, 2, and 4, the second leg 96 is at least ⅓^{rd} of the lower gap 81. As shown in FIGS. 1, 2, and 6 the bend 95 has a radius of 0.02 inches but may have a radius in the range of at least 0.01 inches to 0.50 inches. In alternative embodiments, shown in FIGS. 5 and 6, respectively, the second leg 96 may be omitted and/or the radius of the bend 95 may be increased. An increased radius may also be included between the shoulder 75 and the lower portion 76b of the annular sidewall 76 (FIG. 6) of the collar 70 to accommodate the increased radius of the bend 95. In other alternative embodiments, shown in FIGS. 7 and 8, respectively, the bend 95 and the shoulder 75 may include a chamfered section or the first leg 94 and the shoulder 75 may be convex.

The clearance 92 is configured to receive and securely fit around the outer gland 71 included on the collar 70. The first leg 94 is positioned within the lower annular gap 81 and extends outwardly substantially perpendicular to the annular sidewall 76 in a surface-to-surface relationship with the shoulder 75 of the outer gland 71. The second leg 96 is also positioned within the lower annular gap 81 and extends toward the flange 82 perpendicularly from the first leg 94 in a surface-to-surface relationship with the annular sidewall 76 of the collar 70. In this arrangement, the retainer 90 functions to exert an inward force F_{A} (see FIG. 1) and lock the collar 70 within the clearance 92 axially (via the first leg 94) and transversely (via the second leg 96) to protect the filter cartridge 10 from bursting under an increase in pressure within the filter cartridge 10 during filtration. The first leg 94 extends outwardly to a plurality of peripheral beads 98 (see FIG. 1) arranged in an annular, radially-spaced array. The retainer 90 is rotated about the shoulder 75 until the beads 98 interlock with corresponding notches 77. This arrangement provides for a torque locking mechanism between the collar 70 and the retainer 90.

In the disclosed embodiment, the lower end of the housing 30 is a gravitational bottom and provides for a sump 38. This arrangement is advantageous in certain liquid filter applications such as fuel filtration where heavier water can fall to the sump 38 where it is collected. Water droplets coalesced and separated outside of the filter media 52 collect in the sump 38 over time. To allow for drainage of water collected in the sump 38, the housing 30 may include a drain opening 40 that is formed through an otherwise closed lower end wall of the housing 30. A drain cock (i.e. valve) can be connected to the lower end and has an open position for allowing drainage through the drain opening 40 and a closed position for preventing drainage through drain opening 40. Alternatively, a water collection bowl may be connected at drain opening 40.

In the disclosed embodiment, the housing 30 is constructed of steel sheet metal and the collar 70 is made of plastic but a person having ordinary skill in the art would appreciate that other materials are compatible with the disclosed filter cartridge 10.

While an embodiment of the disclosed filter cartridge locking assembly 10 has been set forth for purposes of illustration, the foregoing description should not be deemed a limitation of the invention. Accordingly, various modifications, adaptations and alternatives may occur to one skilled in the art without departing from the spirit of the disclosure and the scope of the claimed coverage.

1. A filter cartridge comprising:
a filter housing defining a cavity and including a first end, a second end and an annular sidewall therebetween;
a filter element situated within the housing and defining an annular filtration space therebetween, the filter element including a cylindrical ring of filter media disposed about a longitudinal axis and extending axially between a first endcap and a second endcap, the first endcap defining an outlet, and the outlet having a first gland receiving a first annular seal;
a collar including a first end, a second end, at least one notch formed between the first and second ends, mounting threads positioned between the first and second ends, an annular outwardly extending flange positioned between the threads and the second end, a first annular gap defined between the threads and the flange having a first axial length, and a second annular gap defined between the flange and the second end having a second axial length, the first end of the collar including a second gland receiving a second annular seal, said second end of the collar fitting into to the first end of the housing and including a third gland receiving a third annular seal to form a sealed engagement therebetween;
a circumferential retainer included at the first end of the housing receiving the second end of the collar, the retainer having a first leg extending radially outwardly, a second leg extending substantially perpendicular to the first leg, and at least one peripheral bead, and
wherein, said second leg interacts with the second annular gap and the at least one bead engages the at least one notch to form a rotationally locked coupling between the housing and the collar.

2. The filter cartridge of claim 1, wherein the retainer defines an outwardly flared annular clearance for receiving the second end of the collar.

3. The filter cartridge of claim 1, wherein the retainer defines an outwardly flared annular clearance for receiving the gland included on the second end of the collar.

4. The filter cartridge of claim 1, wherein the second annular gap is defined between the flange and the outer gland.

5. The filter cartridge of claim 1, wherein the second leg has a length of at least 0.02 inches.

6. The filter cartridge of claim 1, wherein the collar includes an annular sidewall adjacent to the flange.

7. The filter cartridge of claim 6, wherein the second annular gap is defined by the flange and the annular sidewall.

8. The filter cartridge of claim 6, wherein the second leg is oriented parallel to the annular sidewall.

9. The filter cartridge of claim 6, wherein the second leg interacts with the annular sidewall in a surface-to-surface relationship.

10. The filter cartridge of claim 6, wherein the outer gland comprises an upper shoulder and the second leg is positioned between the flange and the shoulder.

11. The filter cartridge of claim 10, wherein the annular wall is perpendicular to the upper shoulder and the first end of the housing is in a surface-to-surface relationship with the annular wall and the upper shoulder.

12. The filter cartridge of claim 1, wherein the collar includes a plurality of notches arranged in an annular array radially around a periphery of the collar.

13. The filter cartridge of claim 1, wherein the housing is constructed out of metal.

14. The filter cartridge of claim 1, wherein the collar is constructed out of plastic.

15. The filter cartridge of claim 1, wherein a bend having a radius of at least 0.02 inches extends between the first and second legs.

16. The filter cartridge of claim 1, wherein the shoulder and the bend include a chamfered section.

17. The filter cartridge of claim 1, wherein the shoulder and the first leg are convex.

18. A method of making a filter cartridge comprising:
providing a filter housing defining a cavity and including a first end, a second end and an annular sidewall therebetween;
inserting a filter element into the housing, defining an annular filtration space therebetween, the filter element including a cylindrical ring of filter media disposed about a longitudinal axis and extending axially between a first endcap and a second endcap, the first endcap defining an outlet flow tube, and the outlet including an inner gland receiving an inner annular seal;
fitting a collar into the first end of the housing; the collar including a first end, a second end, at least one notch formed between the first and second ends, mounting threads positioned between the first and second ends, an annular outward extending flange positioned between the threads and the second end, a first annular gap defined between the threads and the flange having a first axial length, and a second annular gap defined between the flange and the second end having a second axial length, said first end of the collar including an intermediate gland receiving an intermediate annular seal, said second end of the collar including an outer gland receiving an outer annular seal;
forming a circumferential retainer at the first end of the housing, said retainer receiving the second end of the collar and said retainer having a first leg extending radially outwardly, a second leg extending substantially perpendicular to the first leg, and at least one peripheral bead, and
wherein positioning said second leg into the second annular gap and engaging the at least one bead with the at least one notch forms a rotationally locked coupling between the housing and the collar.

19. The method of claim 18, wherein the retainer defines an outwardly flared annular clearance, and the step of forming the circumferential retainer includes receiving the second end of the collar.

20. The method of claim 18, wherein the step of forming the circumferential retainer includes the retainer and the collar interacting in a surface-to-surface relationship.
